(19) United States
(12) Patent Application Publication
(10) Pub. No.: US 2017/0183034 A1
(43) Pub. Date: Jun. 29, 2017

(54) SENSING DEVICE, SENSING SYSTEM AND STEERING SYSTEM

(71) Applicant: Robert Bosch GmbH, Stuttgart (DE)

(72) Inventors: Zhichao Hong, Suzhou (CN); Baichao Tong, Suzhou (CN); Desheng Zhao, Suzhou (CN); Dong Sun, Suzhou (CN)

(21) Appl. No.: 15/388,551

(22) Filed: Dec. 22, 2016

(30) Foreign Application Priority Data
Dec. 25, 2015 (CN) 201521101238.X

(51) Int. Cl. B62D 15/02; G01D 5/16; B62D 3/12; G01D 5/14; B62D 1/04; B62D 5/04

(52) U.S. Cl. CPC B62D 15/022; B62D 1/04; B62D 5/0424; B62D 3/12; G01D 5/145; G01D 5/16

(57) ABSTRACT

A sensing device includes: an encoder rotating with a rotation shaft and having an external surface with an alternating structure made of magnetic material; at least one magnet facing the external surface and arranged to be fixed outside the encoder; and at least one sensing element arranged to be fixed between the at least one magnet and the encoder and output an alternating signal from the alternating structure as the encoder rotates, wherein the sensing element is a sensing element sensitive to a magnetic field.

### BACKGROUND OF THE INVENTION

The invention relates to electronics, especially to a sensing device, a sensing system and a steering system.

In various applications, it is often necessary to measure physical parameters of various rotation shafts (e.g. a steering shaft of a vehicle, a rotation shaft of a motor or the like), such as rotation speed, rotation angle, etc.

For example, a steering angle sensing device is a common type of sensing device for measurement of rotation and usually applied in a vehicle, for example, as a part of a vehicle-mounted system, such as an Electronic Stability Program (ESP) system, an ABS system or the like. It can be used to measure rotation angle as well as rotation direction, speed, etc. of a steering wheel. An automobile can have its steering amplitude achieved in accordance with the measured rotation angle of its steering wheel, so that the automobile can be turned and driven according to the driver's intention.

There are many types of sensing devices for measurement of rotation in the prior art including a sensor having Optical Couplers (OCs), a magneto electric sensor having Hall elements or Giant Magneto Resistive (GMR) elements, or the like.

However, the conventional sensing devices for measurement of rotation generally have relatively complex configurations and relatively large volumes.

### SUMMARY OF THE INVENTION

In view of the problem described above, the present invention provides a sensing device, a sensing system and a steering system to completely or at least partially solve the problem.

In one aspect of the present invention, a sensing device is provided, comprising: an encoder rotating with a rotation shaft and having an external surface with an alternating structure made of magnetic material; at least one magnet facing the external surface and fixed outside the encoder; and at least one sensing element arranged to be fixed between the at least one magnet and the encoder and output a periodic signal due to the alternating structure as the encoder rotates, wherein the sensing element is a sensing element sensitive to magnetic field.

In one embodiment of the present invention, the alternating structure is a periodic structure.

In one embodiment of the present invention, the at least one sensing element includes a plurality of sensing elements which are arranged to make the phase difference between output signals from any two adjacent sensing elements remain the same.

In one embodiment of the present invention, the external surface is the lateral surface of the encoder along the axial direction of the rotation shaft; and the at least one magnet and the at least one sensing element are arranged radially along a circumference around the encoder.

In one embodiment of the present invention, the alternating structure is a gear structure.

In one embodiment of the present invention, the at least one sensing element aligns with the same one part of the gear structure.

In one embodiment of the present invention, the at least one magnet includes a plurality of magnets which are in one to one correspondence with the plurality of sensing elements.

In one embodiment of the present invention, the sensing element sensitive to magnetic field is a Hall sensor or a GMR sensor.

In another aspect of the present invention, a sensing system is provided, comprising the sensing device described above and further comprising a computing unit that is operable to calculate the rotation speed and/or the rotation angle of a rotation shaft based on the output signal from the sensing device.

In yet another aspect of the present invention, a steering system is provided, comprising: the sensing device described above; a processing device operable to determine the steering angle based on the output signal from the sensing device; and a driving device operable to drive the wheels of the vehicle to steer according to the steering angle.

The above-mentioned sensing device, sensing system and steering system in the present invention provide a measurement system for steering angle that has a simple configuration and a smaller volume by utilizing Hall effect or GMR effect elements or the like.

### BRIEF DESCRIPTION OF THE DRAWINGS

Other features, characteristics, advantages and benefits of the present invention will become more apparent from the following detailed description in combination with accompanying figures.

FIG. 1 shows an exemplary environment in which a sensing device may be applied;

FIGS. 2a and 2b show structural diagrams of a steering angle sensor based on Hall effect or GMR effect in the prior art;

FIG. 3 shows a structural diagram of a sensing device in accordance with an embodiment of the present invention;

FIGS. 4a and 4b show schematic diagrams illustrating the operating process of a sensing device in accordance with an embodiment of the present invention;

FIG. 4c shows a schematic diagram of output waveform of a sensing device;

FIG. 5a shows a structural diagram of a sensing device in accordance with another embodiment of the present invention;

FIG. 5b illustrates the relationship between output signals from multiple sensing elements;

FIG. 6 shows a structural diagram of a sensing device in accordance with another embodiment of the present invention; and

FIG. 7 shows a structural diagram of a steering system in accordance with an embodiment of the present invention.

### DETAILED DESCRIPTION

Exemplary embodiments of the disclosure will be described in further detail with reference to the figures. Although the exemplary embodiments of the disclosure are shown in the figures, it is to be appreciated that the disclosure can be implemented in various forms without being limited by the embodiments described herein. Rather, the embodiments are provided to make the disclosure more thoroughly understood and convey the full scope of the disclosure to those of ordinary skills in the art.

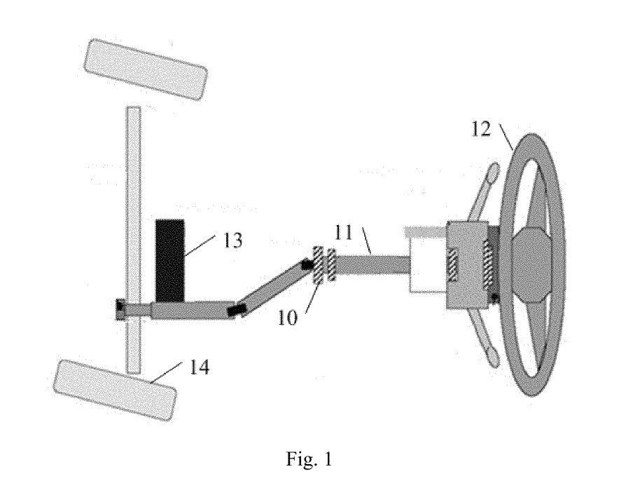

FIG. 1 shows an exemplary environment in which a sensing device can be applied. As shown in FIG. 1, a sensing device 10 provided by the present invention is mounted on a steering shaft 11 of a vehicle that rotates with a steering wheel 12. The steering angle sensing device 10 acts as a part of a ESP system with its output signal transferred to a control and driving device 13 of the ESP system. For example, the control and driving device 13 includes an electronic control unit (ECU), a motor, a steering gear and the like, and controls steering of wheels 14 according to the information output from the steering angle sensing device 10.

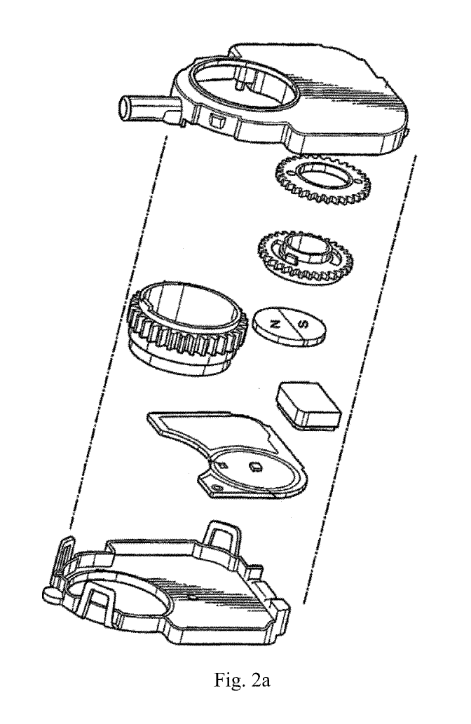

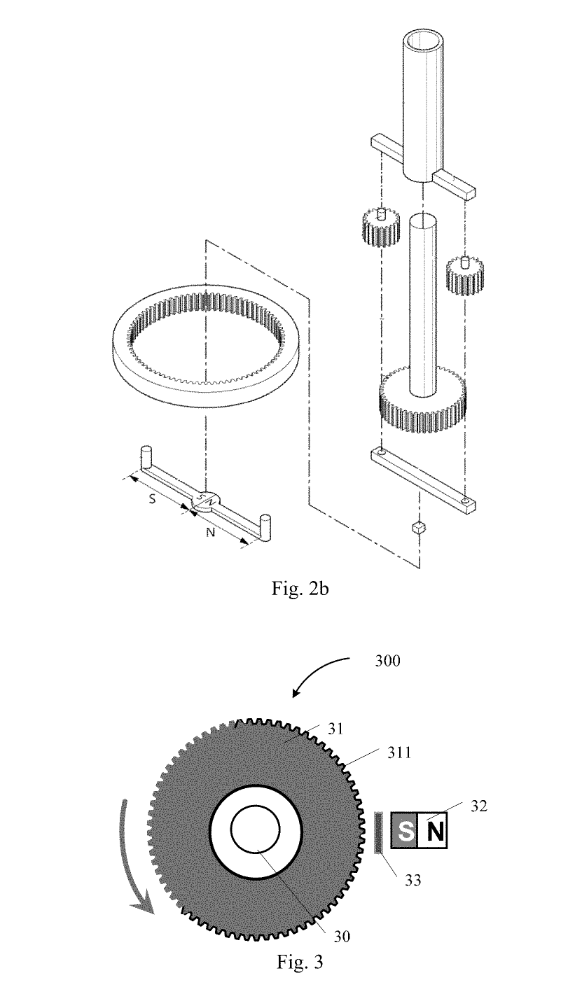

FIGS. 2a and 2b show structural diagrams of a steering angle sensor based on Hall/GMR effect in the prior art. As shown in the figure, the steering angle sensor typically has a relatively complex configuration usually including a driving gear and a plurality of driven gears in addition to a magnet, and thus results in a relatively large volume. Furthermore, the mutual contact and influence between the gears may bring about such problems as noises etc. Further, this type of steering angle sensor is inconvenient to mount.

Embodiments of the present invention will be detailed in the following. To make the present invention better understood, the principles of Hall effect and GMR effect involved in some embodiments of the present invention will be briefly introduced before embodiments of the present invention are described in detail.

The Hall effect means that when being perpendicular to the direction of a current, carriers (e.g. electrons and holes) deflect due to Lorentz force and accumulate in a direction perpendicular to those of the current and a magnetic field, and the accumulated electrons and holes generate an electric field with a direction perpendicular to those of the current and the magnetic field; when the carriers experience balanced electric field force and Lorentz force, a steady state is arrived at and a stable built-in voltage, known as a Hall voltage, is formed in the direction perpendicular to those of the current and the magnetic field.

The GMR effect refers to significant changes of resistance in a magnetic material caused by change of magnetic field.

FIG. 3 shows a structural diagram of a sensing device in accordance with an embodiment of the present invention. The sensing device is used in a steering system of a vehicle, in which case the rotation shaft is the steering shaft connected with the steering wheel. Specifically, FIG. 3 shows a cross-sectional view along the axial direction. As shown in FIG. 3, the sensing device 300 includes an encoder 31, a magnet 32 disposed outside the encoder 31 and a sensing element 33 disposed between the magnet 32 and the encoder 31.

It can be known from FIG. 1 that in practical application the encoder 31 is attached to the steering shaft 30 connected with the steering wheel and thus rotates with it. The magnet 32 and the sensing element 33 are fixed in positions outside the encoder 31. When the driver turns the steering wheel, the steering shaft 30 and in turn the encoder 31 are rotated. Relative movement is formed between the encoder 31 and the fixed magnet 32 and sensing element 33.

In this embodiment of the present invention, the external surface of the encoder 31 that moves relatively with respect to the magnet 32 and sensing element 33 is made of magnetic material. Of course, other parts of the encoder 31 other than the external surface 311 may also be made of magnetic material, for example, the encoder 31 as a whole is made of magnetic material. In this way, the external surface 311 together with the magnet 32 on the other side of the sensing element 33 generates a substantially orthogonal magnetic field passing through the sensing element 33. For example, in the static position shown in FIG. 3, the direction of the magnetic field may be substantially horizontally rightward. Correspondingly, when the sensing element 33 is, for example, a Hall sensor, it is arranged to make the direction of current perpendicular to that of the magnetic field.

In the example shown in FIG. 3, the encoder 31 is approximately cylindrical, and the magnetic external surface of the encoder 31 is the lateral surface of the steering shaft 30. In this case, the magnet 32 and the sensing element 33 are disposed radially outside the encoder 31.

Of course, the magnetic external surface 311 of the encoder 31 can also be implemented in other ways. For example, the magnetic external surface 311 of the encoder 31 may be the upper surface or lower surface of the encoder 31. In this case, the magnet 32 and the sensing element 33 are disposed in fixed positions relative to the upper surface or lower surface of the encoder 31. Thereby, the encoder 31 rotates correspondingly with respect to the magnet 32 and the sensing element 33 as the steering shaft 30 rotates.

In this embodiment of the present invention, the external surface 311 of the encoder 31 has a periodic structure, such as a regular lattice structure, a regular convex-concave structure or the like. As the encoder 31 rotates, different parts of the lattice structure or convex-concave structure of the encoder 31 align with the sensing element 33 alternately. In the specific example shown in FIG. 3, the periodic structure is shown to be a gear structure having convex teeth and tooth spaces between adjacent teeth.

The magnet 32 may be a permanent magnet, a soft magnet or various other elements that can generate magnetic field, which has no limitation on the present invention.

The sensing element 33 may be a Hall sensor and/or a GMR sensor.

With the arrangement described above, the sensing element 33 aligns with varying part of the periodic structure of the external surface 311 of the encoder 31, i.e. the distance between the external surface 311 and the magnet 32 varies periodically as the encoder 31 rotates with respect to the magnet 32 and the sensing element 33. Thereby a magnetic field that varies periodically is formed on the sensing element 33.

In the case that the sensing element 33 is a Hall sensor, according to the principle of Hall effect explained above, when the Lorentz force experienced by carriers in the Hall sensor varies periodically, the electric field force to balance the Lorentz force varies with it. The electric field force is provided by a Hall voltage in a direction perpendicular to those of the current and the magnetic field. That is to say, as the encoder 31 rotates, a Hall voltage that varies periodically will be generated in the Hall sensor as the sensing element 33 in a direction perpendicular to those of the current and the magnetic field. The steering angle can be calculated based on the variation of the Hall voltage.

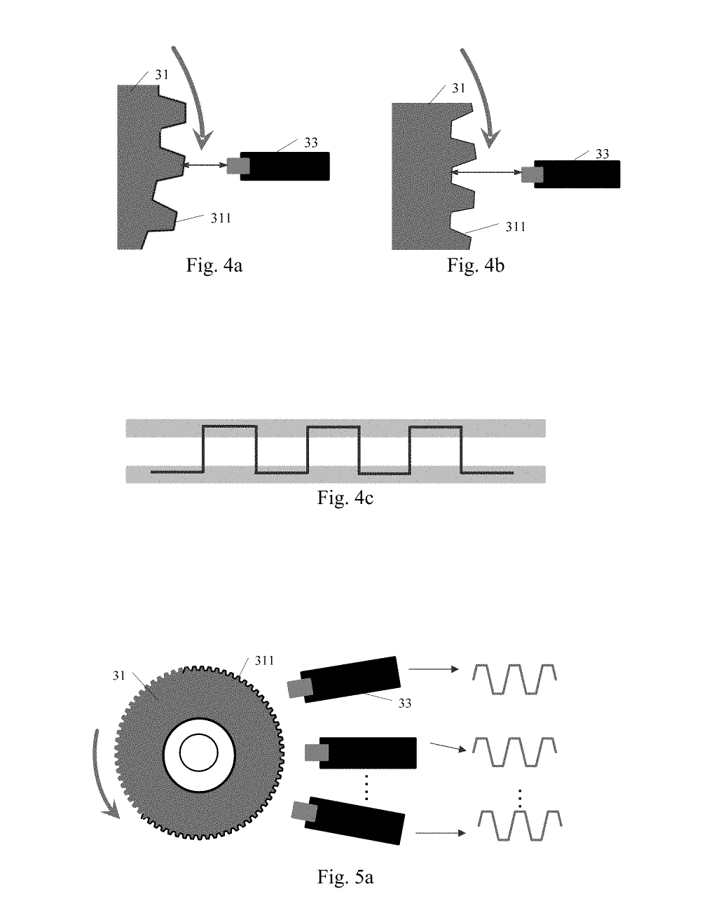

Similarly, in the case that the sensing element 33 is a GMR sensor, the variation of the magnetic field leads to variation of resistance. Therefore, if the voltage remains constant but the current varies periodically, the steering angle can also be calculated accordingly. The function of the periodic structure of the external surface 311 of the encoder 31 lies, on the one hand, in forming different Hall voltages by variation of distance, and on the other hand, in indicating the steering angle through its physical size. In the following, the operating process of the steering angel sensing device shown in FIG. 3 will be illustrated with reference to FIGS. 4a-4c.

FIGS. 4a-4c show the operating process and output waveform of the steering angle sensing device in the present embodiment of the invention. It is assumed that the position of the encoder 31 shown in FIG. 4a is a first position, for example, an initial position. In this position, the sensing element 33 aligns with a tooth on the external surface 311 of the encoder 31 and a Hall voltage with a relatively high level is generated in the sensing element 33 in a direction perpendicular to direction of the magnetic field. As shown in FIG. 4b, the encoder 41 is rotated clockwise along with the steering shaft by a relatively small angle and, in this position the sensing element 33 may align with a tooth space on the external surface 311 of the encoder 31, so that the Hall voltage becomes a lower level. If the rotation angle is relatively large and covers multiple teeth and tooth spaces, a voltage signal having alternating high and low amplitudes will be generated as shown in FIG. 4c.

Moreover, with reference to FIGS. 4a and 4b, it can be appreciated that if the sensing device is a single sensing element, the precision with which the steering angle can be measured by the sensing device depends partially on the number of the teeth on the external surface of the encoder, and the more the teeth are provided, the smaller is the rotation angle that the steering angle sensing device is capable of detecting.

It is to be noted that if there is only one sensing element, it is difficult to determine the direction of rotation accurately according to the output signal from that sensing element, and, in view of this, the direction can be determined in an existing way for determination of rotation direction, for example, the direction of rotation can be determined through optical detection.

In accordance with the operating principle of the embodiment of the present invention described above, other types of sensing elements sensitive to magnetic field can be used, such as a magneto resistor, a magneto transistor, an integrated circuit including magneto resistors and magneto transistors or the like, as long as such elements can sense the periodic variation of magnetic field caused by the rotation of the encoder and output a corresponding periodic signal.

The embodiment described above takes the measurement of steering angle of a steering shaft as an example to illustrate the structure of the sensing device in the present invention. However, it should be understood that the sensing device in the embodiment of the present invention can also be applied in measurement of rotation speed of a motor etc. rather than being limited to the measurement of angle of a steering shaft.

It can be understood by those of ordinary skills in the art that when the sensing device in the embodiment described above is used for measurement of rotation speed, especially a high rotation speed (e.g. multiple cycles per second), the external surface does not necessarily have a periodic structure that is completely regular, but rather a simple alternating structure. For example, for the encoder in FIG. 3, the lateral surface of the encoder along its axial direction only partially includes protruding parts. Correspondingly, the sensing element outputs an alternating signal, for example, when the encoder rotates to a position in which its protruding part aligns with the sensing element, the sensing element outputs a signal with a high level, while at other times it outputs a signal with a low level.

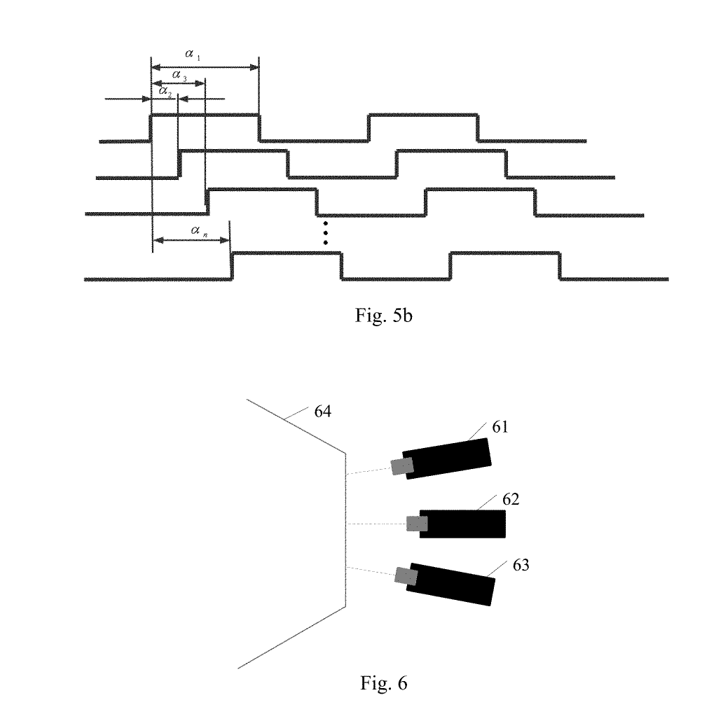

FIG. 5a shows a structural diagram of a sensing device in accordance with another embodiment of the present invention. As shown in FIG. 5a, the sensing device in the present embodiment includes a plurality of sensing elements 33. Similar to the previous embodiment, the magnet is fixed outside the encoder 31, the sensing elements 33 are located between the magnet and the encoder 31, and the external surface 311 of the encoder 31 opposite to the sensing elements 33 has a periodic structure made of magnetic material. Specifically, the magnet and the plurality of sensing elements 33 are arranged radially along a circumference around the encoder 31.

The plurality of sensing elements 33 may be Hall sensors, GMR sensors or combinations thereof. For simplification of illustration, the magnet is not shown in the figure. When the plurality of sensing elements 33 include not only Hall sensors, but also GMR sensors, the sensing device may further include a signal conversion circuit to, for example, convert the periodical voltage signals from the Hall sensors into current signals so as to facilitate calculation of angle.

In a specific implementation of this embodiment of the present invention, there are a plurality of magnets which are in one to one correspondence with the plurality of sensing elements.

Specifically, in the present embodiment, the plurality of sensing elements are arranged to make the phase difference between output signals from any two adjacent sensing elements remain the same. Thereby, the plurality of sensing elements may be distributed to correspond to different teeth or be centralized to correspond to the same one tooth.

FIG. 5b shows a graph illustrating the output waveforms of the plurality of sensing elements. As shown in FIG. 5b, for n sensing elements, if it is assumed that a high-level signal has a phase difference of α₁, the phase difference between the first sensing element and the second sensing element is α₂, the phase difference between the first sensing element and the third sensing element is α₃, the phase difference between the first sensing element and the nth sensing element is αₙ, it can be known that α₂=1/nα₁, α₃=2/nα₁, and αₙ=(n−1)/nα₁. Thereby, it can be seen by those of ordinary skills in the art that if outputs from two adjacent sensing elements successively appear, the sensing device can be aware that the steering shaft has rotated, and therefore the smallest angle the sensing device can distinguish corresponds to the phase difference of α₂/nα₁. It can be seen that if the number n of the sensing elements is more than one, the precision of the sensing device can be improved.

On the other hand, similar to the previous embodiment, the precision in detection of steering angle also depends on the number of teeth of the encoder. If the number of teeth is z, the steering angle corresponding to the phase differential of α1 is 360/z, and thereby it can be seen that the precision of the sensing device is 360/nz. Those of ordinary skills in the art can choose appropriate numbers of the teeth and the sensing elements based on practical requirements to meet different precision demands.

FIG. 6 shows a specific implementation of the sensing device in the present embodiment of the invention. As shown in FIG. 6, the sensing element usually has a relatively small size, which is far less than the size of the tooth on the encoder. In the present embodiment, a plurality of sensing elements 61, 62 and 63 are distributed along a circumference around the encoder and align with the same one tooth 64 in such a way that the radians between any two adjacent sensing elements are equal to each other. This ensures that the phase difference between output signals from any two adjacent sensing elements remains the same.

Furthermore, it should be appreciated that with the configuration of a plurality of sensing elements in the present embodiment, the rotation direction of the steering shaft may be determined based on the phase differences between output signals from the plurality of sensing elements.

The sensing device provided in any embodiment of the present invention described above, as a whole, can be implemented as a separate sensor. For example, the sensor includes a packaging enclosure as well as a fixed part and a movable part. The magnets and the sensing elements are mounted on the fixed part and the encoder is configured to be a movable and rotatable part. In practice, such a steering angle sensor is mounted on a steering shaft to make the encoder rotate with the steering shaft. When such a sensor is implemented, the Hall voltage can be output directly as an output signal. Of course, some other signal processing circuits, such as a shaping circuit etc., can be included in the sensor to process the Hall voltage signal and output the processed signal as an output signal. Of course, the device for measuring steering angle in embodiments of the present invention can also act as a part of a vehicle-mounted system, such as a ESP system or the like, and completely or partially implemented through discrete electronic elements.

The sensing device in embodiments of the present invention described above consists of encoder, sensing element and magnet, which has a simpler configuration and a smaller volume compared to the existing configuration carried out by a plurality of driving and driven gears. Furthermore, the encoder, sensing element and magnet in the sensing device are not in contact with each other. The contactless configuration can also avoid such problems as noises caused by mutual contact of gears etc.

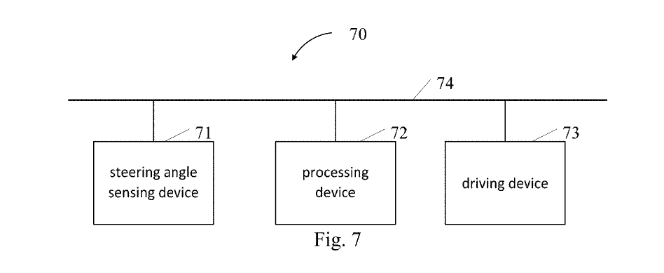

FIG. 7 shows a structural diagram of a steering system in an embodiment of the present invention. As shown in FIG. 7, the steering system 70 includes a sensing device 71, a processing device 72 and a driving device 73.

The processing device 72 may be a VCU (Vehicle Control Unit) or any other vehicle-mounted controller, which calculates steering angle based on the output signal from the sensing device 71 and outputs the information on the calculated steering angle. In some implementations, it can also detect and output steering direction based on the output signal from the sensing device 71.

The driving device 73 may include a steering gear, a motor or the like to drive the wheels to steer according to the steering angle and direction calculated by the processing device 72.

The sensing device 71, the processing device 72 and the driving device 73 may be connected through, for example, a CAN bus 74 or in other ways.

For example, the steering system in the embodiment of the invention may be an ESP system, in which the specific positions of the processing component, the driving device etc. can be seen in FIG. 1.

A sensing system is further provided in an embodiment of the present invention to acquire information of rotation speed, rotation angle etc. The sensing system includes the sensing device in any embodiment described above and a computing unit that is used to calculate the rotation speed and/or the rotation angle of a rotation shaft based on the output signal from the sensing device. Similar to the sensing device, the sensing system may be implemented in an integrated or discrete form.

In an example, the sensing system may be a system to measure rotation of a motor. Wherein the computing unit may be an MCU, a Microcontroller or an Application Specific Integrated Circuit (ASIC) and the rotation shaft is one of a motor.

It can be understood by those of ordinary skills in the art that various changes and modifications may be made to the embodiments disclosed above without departing from the spirit of the present invention. The scope of the present invention should be defined by the appended claims.

1. A sensing device, comprising:
an encoder rotating with a rotation shaft and having an external surface with an alternating structure made of magnetic material;
at least one magnet facing said external surface and fixed outside said encoder; and
at least one sensing element arranged to be fixed between said at least one magnet and said encoder and to output an alternating signal due to said alternating structure as said encoder rotates,
wherein said sensing element is sensitive to a magnetic field.

2. The sensing device of claim 1, characterized in that said alternating structure is a periodic structure.

3. The device of claim 2, characterized in that said at least one sensing element includes a plurality of sensing elements which are arranged to make a phase difference between output signals from any two adjacent sensing elements remain the same.

4. The device of claim 1, characterized in that said external surface is a lateral surface of said encoder along an axial direction of the rotation shaft; and
said at least one magnet and said at least one sensing element are arranged radially along a circumference around said encoder.

5. The sensing device of claim 4, characterized in that said alternating structure is a gear structure.

6. The sensing device of claim 5, characterized in that said at least one sensing element aligns with the same one part of said gear structure.

7. The sensing device of claim 3, characterized in that said at least one magnet includes a plurality of magnets which are in one to one correspondence with said plurality of sensing elements.

8. The sensing device of claim 1, characterized in that said sensing element sensitive to magnetic field is a Hall sensor or a GMR sensor.

9. A sensing system comprising the sensing device of claim 1 and a computing unit to calculate a rotation speed and/or a rotation angle of said rotation shaft based on the output signal from said sensing device.

10. A steering system used for measuring steering angle of a steering shaft of a vehicle, comprising:
the sensing device of claim 1;
a processing device operable to determine said steering angle based on the output signal from said sensing device; and
a driving device operable to drive wheels of the vehicle to steer based on said steering angle.
